(19) United States
(12) Patent Application Publication
(10) Pub. No.: US 2017/0219843 A1
(43) Pub. Date: Aug. 3, 2017

(54) MODULAR PAIR OF SPECTACLES

(71) Applicant: Laurent ALBOUY, Lille (FR)

(72) Inventor: Laurent ALBOUY, Lille (FR)

(21) Appl. No.: 15/500,681

(22) PCT Filed: Jul. 23, 2015
(86) PCT No.: PCT/FR2015/052048

§ 371 Date: Jan. 31, 2017

(30) Foreign Application Priority Data
Aug. 1, 2014 (FR) FR1457529

(51) Int. Cl. G02C 1/08; G02C 7/10; G02C 5/14; G02C 7/02

(52) U.S. Cl. CPC G02C 1/08; G02C 7/02; G02C 7/10; G02C 5/14; G02C 2200/08

(57) ABSTRACT

Disclosed is a modular pair of spectacles, including a frame which includes a rim and two temples mounted in connection with the side ends of the rim. The rim is provided with an upper portion, a lower portion and assembly unit between the portions. The upper portion includes at least of the side ends thereof a first longitudinal semi-connection portion and the lower portion includes at each of the side ends thereof a second longitudinal semi-connection portion. The first and second longitudinal semi-connection portions complement one another and are configured such that, upon assembling the upper portion and the lower portion, the first and second portions form a first female or male connection unit, configured to receive a second male or female connection element, arranged at the end of each respective temple. Aldo disclosed is a kit for forming such a pair of spectacles.

The present invention relates to a modular pair of spectacles which advantageously enables the disassembly of the frame thereof so as to be able to adapt said frame and the lenses assembled thereon. As such, the pair of spectacles can be customised as desired or to match clothing, and it can be adapted according to correction and/or sun protection requirements.

Modular pairs of spectacles are known to those skilled in the art, particularly those described in the patent applications or patent published under the numbers WO 2012/074414 A1, US 2009/0279047 A1, WO 2011/149364 A1, GB 734208 and US 2014/0063442 A1.

In the document WO 2012/074414 A1, the pair of spectacles comprises a frame suitable for being disassembled which comprises a lens rim consisting of an upper portion and a lower portion. Assembly means are implemented between said upper and lower portions so as to keep same assembled together once the lenses have been positioned inside the rim formed by said portions. The temples of the rim are assembled in a manner suitable for being disassembled with the respective lateral sides of the rim. For this, the upper portion of the rim comprises, on both lateral sides thereof, a first horizontal flat section from which extend vertically on each side, an upper stud and a lower stud, the two studs forming a single pivoting axis. Furthermore, the lower portion of the rim comprises on both lateral sides thereof a second horizontal flat section provided with a through hole extending vertically and which is configured to receive the respective lower stud. Upon the assembly of the lower portion and the upper portion of the rim, on each of the lateral sides, the second flat section is arranged adjacently below the first flat section with the lower stud which passes through the through hole and which extends below the second flat section. As such, the end portion of the lower stud and the upper stud form said pivoting axis together whereon the respective spectacle temple is assembled in a pivot connection. Each temple comprises at the end thereof an upper flat section and a lower flat section, said upper and lower flat sections being separated from one another by a width corresponding to the total thickness of the adjacent first and second flat sections of the rim formed once the lower and upper portions have been assembled. These upper and lower flat sections each comprise a circular inner notch, the notches being configured to receive the upper stud and the end portion of the lower stud, respectively. Upon mounting the temples on the rim, the upper and lower flat sections, mounted in a pivot connection on the upper stud and the end portion of the lower stud, respectively, prevent the release of the second flat section with respect to the first flat section, adjacent to one another, which keeps the upper portion and the lower portion of the rim assembled together.

According to one embodiment described in the document US 2009/0279047 A1, the pair of spectacles comprises a frame which comprises a one-piece lens rim. On each lateral side of the one-piece rim, a slot is arranged more or less horizontally and separates said lateral side into an upper side portion and a lower side portion. The slots on the lateral sides enable the deformation of the one-piece rim so as to fit the lens on said rim or, conversely, remove the lenses. On each of the lateral sides, the upper side portion comprises an upper stud which extends upwards, and the lower side portion comprises a lower stud which extends downwards. The upper and lower studs form a single pivoting axis of a temple. Each temple comprises at the end thereof an upper flat section and a lower flat section which each comprise a circular inner notch, enabling said upper flat section to receive the upper stud and said lower flat section to receive the lower stud, so as to mount in a pivot connection the temple on the lateral side of the rim. The distance between the upper and lower flat sections is such that, when the upper and lower studs are respectively engaged in the notches, the slot is tightened, which holds the lenses on the frame rim.

The document WO 2011/149364 A1 describes an embodiment identical to that cited above of the document WO 2012/074414 A1. Moreover, according to a further alternative embodiment described in the document WO 2011/149364 A1, the frame comprises a lens rim consisting of an upper portion and a lower portion, assembly means between said upper and lower portions suitable for keeping same assembled together once the lenses have been positioned inside the rim formed by said portions. The temples of the frame are assembled in a manner suitable for being disassembled with the respective lateral sides of the rim. For this, the upper portion of the rim comprises, on both lateral sides thereof, an upper horizontal flat section wherein a through hole is arranged vertically. Similarly, the lower portion of the rim comprises on both lateral sides thereof a horizontal lower flat section provided with a through hole arranged vertically. Upon the assembly of the lower portion and the upper portion of the rim, on each of the lateral sides, the lower flat section is arranged adjacently below the upper flat section, with the through holes thereof aligned to form a single connection hole. Each temple comprises at the end thereof a flat section from which a stud arranged to be inserted into the connection hole extends downwards, penetrating through the top of the upper flat section and leading to below the lower flat section. The stud comprises at the end thereof an edge forming a stop requiring that said stud be engaged in the connection hole. Once the stud is engaged, the upper and lower flat sections are held in an adjacent position with respect to one another by means of the flat section of the temple which forms a stop on the upper flat section, on one hand, and of the edge which forms a stop on the lower flat section, on the other.

In the patent GB 734208, the pair of spectacles comprises a frame consisting of two upper and lower portions which each comprise at the side ends thereof, longitudinal connection portions. Upon assembly, at each side end of the frame, the two longitudinal connection portions of the upper and lower portions are placed end-to-end, so as to form a first connection element (male or female) enabling the reception of a second connection element (female or male) arranged at the end of the temple. Engaging the second connection element on the first connection element makes it possible to keep the upper and lower portions of the frame assembled. These features are comparable to those cited above and described in the document WO 2011/149364 A1.

In the patent application US 2014/0063442 A1, the frame is split at the side ends thereof, making it possible to form an upper portion and a lower portion by separating the frame at the lateral slots. Two longitudinal connection portions are implemented at the respective side ends of the upper and lower portions. On each lateral side of the frame, the longitudinal connection portion of the lower portion are placed end-to-end with the longitudinal connection portion of the upper portion, tightening the slot, which makes it possible to form the first female connection element which receives a second male connection element at the end of the temple. The second connection element makes it possible to keep the slot tightened, once fitted in the first connection element. These features are comparable to those cited above and described in the document US 2009/0279047 A1.

The aim of the present invention is that of implementing an alternative design of a pair of spectacles compared to those previously known and described in the documents WO 2012/074414 A1, US 2009/0279047 A1, WO 2011/149364 A1, GB 734208 and US 2014/0063442 A1.

As such, the invention relates to a pair of spectacles comprising a frame which comprises a rim and two temples mounted in a pivot connection with the side ends of said rim. The rim is provided with an upper portion, a lower portion and removable assembly means between said portions. Remarkably, the upper portion includes, at each of the side ends thereof, a first longitudinal semi-connection portion and the lower portion includes, at each of the side ends thereof, a second longitudinal semi-connection portion. The longitudinal direction is defined by the trajectory of the axis of the pivot connection between the temple and the rim. The first and second longitudinal semi-connection portions complement one another and are configured so as to form a first female or male connection element, upon assembling the upper portion and the lower portion. This involves cutting the first connection element in the longitudinal direction, i.e. in the direction of the pivoting axis, so as to separate same into two pieces corresponding to the first and second longitudinal semi-connection portions, said first connection element being suitable for being reconstructed by interlocking said two pieces together. This first connection element is configured to receive a second male or female connection element, arranged at the end of each respective temple.

It is understood that the pair of spectacles according to the invention is characterised from the pairs of spectacles according to the prior art, such as those described in the documents WO 2012/074414 A1, US 2009/0279047 A1, WO 2011/149364 A1, GB 734208 and US 2014/0063442 A1, in that these prior art pairs of spectacles envisage an upper longitudinal male or female connection section (and not a first longitudinal semi-connection portion) at each side end of the upper portion of the rim, and a lower longitudinal male or female connection section (and not a second longitudinal semi-connection portion) at each side end of the lower portion of the rim, said male or female upper sections being placed end-to-end to form a first male or female connection element upon assembling said upper and lower portions of the rim. This involves cutting the first pivot connection element into two sections along a plane perpendicular to the longitudinal pivoting axis. This first connection element then receives a second complementary female or male connection element, which is arranged at the end of each temple. According to the prior art, placing the upper and lower sections end-to-end gives rise to rigidity or consolidation problems of the connection elements implemented. Whereas, according to the invention, the semi-connection portions are interdependent, the contact surfaces between the two semi-connection portions being interlocked together, which makes it possible to increase the rigidity of the first connection element by reducing the mobility between the first and second semi-connection portions both along the pivoting axis and perpendicularly to said pivoting axis.

In one preferential design of the pair of spectacles according to the invention, the upper portion of the rim comprises at each of the side ends thereof a first hollow semi-cylindrical portion. Similarly, the lower portion of the rim comprises at each of the side ends thereof a second hollow semi-cylindrical portion. The first and second hollow semi-cylindrical portions complement one another and are configured such that, upon assembling the upper portion and the lower portion, for the formation of the rim, said first and second semi-cylindrical portions are joined and form a hollow cylinder provided with a longitudinal slot designed to enable the engagement of a pin arranged at the end of each respective temple, for mounting the temples on the rim and, conversely, the disengagement of said pin, for the disassembly of the temples from the rim.

It is understood that, according to this preferential design, the hollow cylinder forms a first female connection element and the pin forms a second male connection element. It would be possible to envisage, in an alternative design, a first longitudinal semi-connection portion consisting of a first longitudinal solid semi-cylindrical portion, forming for example a pin segment, and a second longitudinal semi-connection portion consisting of a second longitudinal solid semi-cylindrical portion, forming for example three pin segments, said portions forming a complete pin, i.e. a first male connection element, upon assembling the upper and lower portions of the rim. According to this alternative embodiment, the ends of the temples would thus comprise a second female connection element configured to be engaged on the upper and lower ends of said complete pin. For example, the end of each temple would comprise an upper flat section provided on the inner face thereof with an upper cylindrical notch and a lower flat section provided on the inner face thereof with a lower cylindrical notch, the upper and lower cylindrical notches being arranged facing one another and each provided with a slot for engaging the respective upper and lower ends of the complete pin and the respective reception thereof in said upper and lower cylindrical notches.

According to the pair of spectacles according to the invention, stop means are arranged at the ends of the temples. These stop means are configured to lock the longitudinal translation of the first longitudinal semi-connection portion with respect to the second longitudinal semi-connection portion, after assembling the upper and lower portions of the rim and after mounting each temple on said rim. As such, mounting the temples on the rim prevents any risk of disassembly between the upper and lower portions, at the side ends of said rim.

In one embodiment of the stop means, according to the preferential design cited above of the pair of spectacles according to the invention, each temple comprises at the end thereof an upper flat section and a lower flat section separated from one another by a distance corresponding to the length of the semi-cylindrical portions. The pin of the temple extends between the upper and lower flat sections. These upper and lower flat sections form stops configured to lock the translation along said pin of the first semi-cylindrical portion with respect to the second semi-cylindrical portion, once the upper and lower portions of the rim have been assembled together.

According to one preferential design of the pair of spectacles according to the invention, the assembly means comprise an engagement system arranged between the upper portion and the lower portion of the lens rim, in a central portion of said rim. This offers the advantage of assembling the upper and lower portions of the rim in two phases so as to facilitate the position of the lenses on said rim. Indeed, the user can in a first phase engage the upper and lower portions with one another, in the central portion of the rim, subsequently enabling easy handling of the lenses with one hand while holding the rim with the other hand. Moreover, the respective side ends of the upper and lower portions can be separated slightly in order to insert the lenses into the rim, prior to the assembly thereof at the side ends thereof.

According to this preferential design of the pair of spectacles according to the invention, the lower portion of the lens rim comprises in the central portion thereof a nasal supporting element. Moreover, the engagement system is configured to favour the disengagement of the lower portion with respect to the upper portion by pressing on said nasal supporting element. This ensures the secured assembly of the upper portion with the lower portion in the central portion of the rim upon the disassembly thereof, which prevents any risks of the lenses falling upon disassembling the frame. According to the design of the engagement system, the nasal supporting element can be pressed in one direction or in the other, as detailed hereinafter in the description.

According to one preferential design of the pair of spectacles according to the invention, the assembly means comprise two interlocking systems arranged between the upper portion and the lower portion of the lens rim, at the two side ends of said rim, respectively. This makes it possible to release the upper and lower portions easily at the side ends, once the temples are disassembled from the frame. However, it would be possible to envisage, in an alternative design, engagement systems arranged at the side ends between the upper and lower portions.

In one embodiment of the pair of spectacles according to the invention, according to the preferential design envisaging first and second hollow semi-cylindrical portions, the first semi-cylindrical portion and the second semi-cylindrical portion are configured to increase the flexibility of at least one of said semi-cylindrical portions, so as to facilitate the separation of the slot upon the engagement or disengagement of the temple pin.

The present invention also relates to a kit for forming a pair of spectacles having one or another of the features cited above, or even a plurality of these features. The kit comprises at least one upper lens rim portion, at least one lower lens rim portion, at least one pair of lenses and at least one pair of temples. As such, it is possible to customise the pair of spectacles as desired and/or to match clothing. Preferably, the kit comprises at least two pairs of temples of different colours or patterns.

Preferably, the kit according to the invention comprises at least one pair of corrective lenses and one pair of sun lenses. This makes it possible to adapt the pair of spectacles according to the sunlight conditions.

The invention also relates to a kit comprising a pair of spectacles having the features cited above and a tool configured to enable the disassembly of the temples by inserting said tool into each temple and opening said temple outwards with respect to the lens rim. The tool is configured to enable the release of the second connection element with respect to the first connection element, acting as a lever. In one preferential embodiment, one of the temples comprises a housing area configured to receive and hold the tool in the storage position, making it possible to keep the tool continuously on the pair of spectacles. It could however be envisaged to store the tool independently from the pair of spectacles, for example in a storage case, and to take it out of the case at the time of use thereof.

The following description highlights the features and advantages of the pair of spectacles according to the present invention. This description is based on figures, wherein:

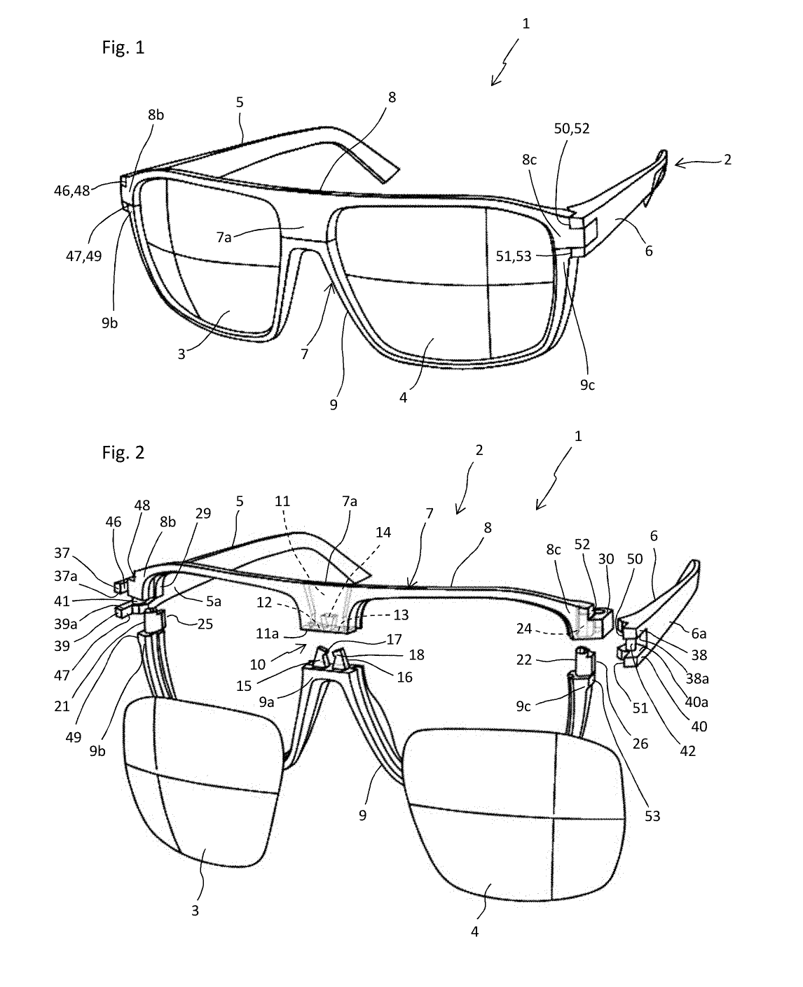

FIG. 1 illustrates a pair of spectacles according to the invention;

FIG. 2 illustrates the pair of spectacles in FIG. 1, in an exploded view;

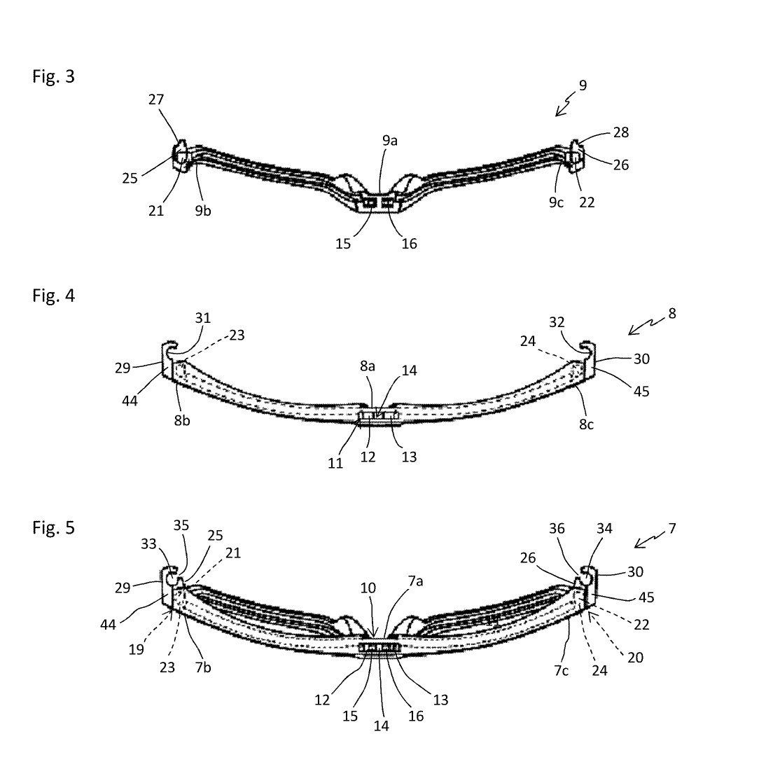

FIGS. 3 to 5 respectively illustrate the lower portion of the rim, the upper portion of the rim, and the rim once said portions have been assembled, according to a first embodiment;

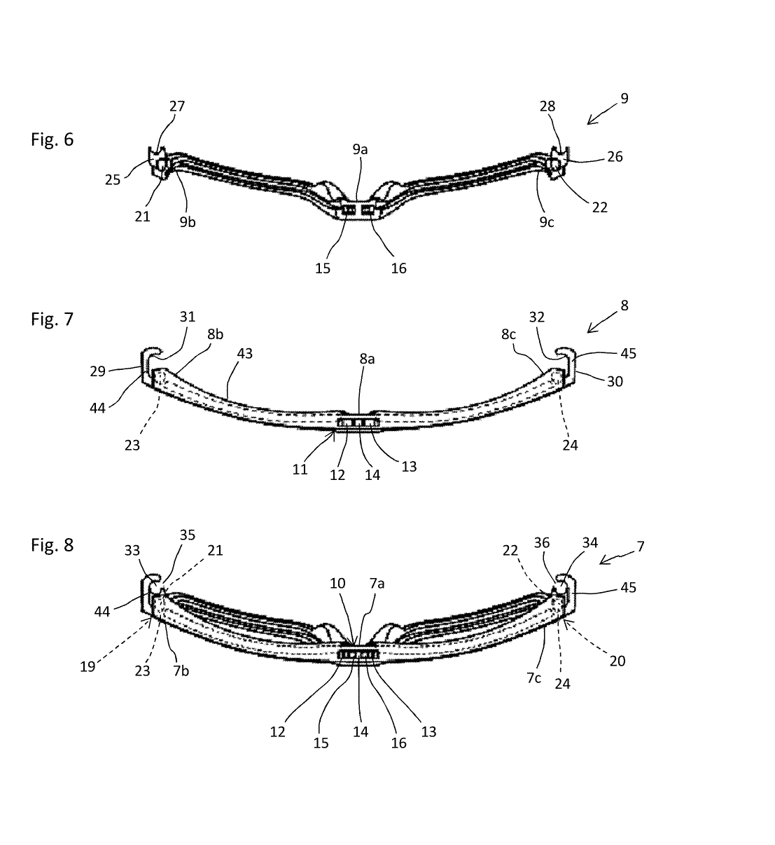

FIGS. 6 to 8 respectively illustrate the lower portion of the rim, the upper portion of the rim, and the rim once said portions have been assembled, according to a second embodiment;

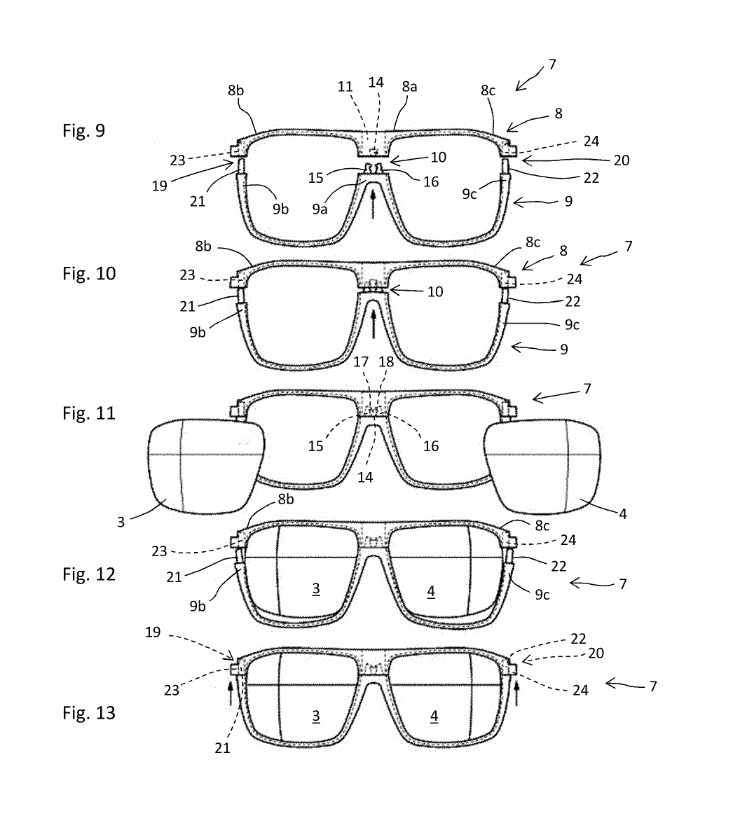

FIGS. 9 to 13 illustrate the various steps for mounting the lens rim;

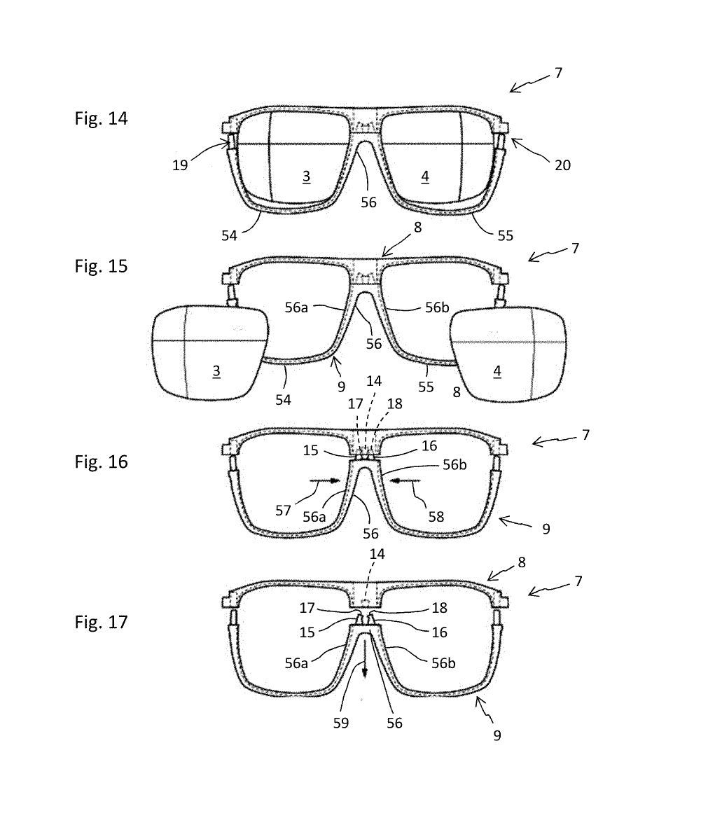

FIGS. 14 to 17 illustrate the various steps for disassembling the lens rim;

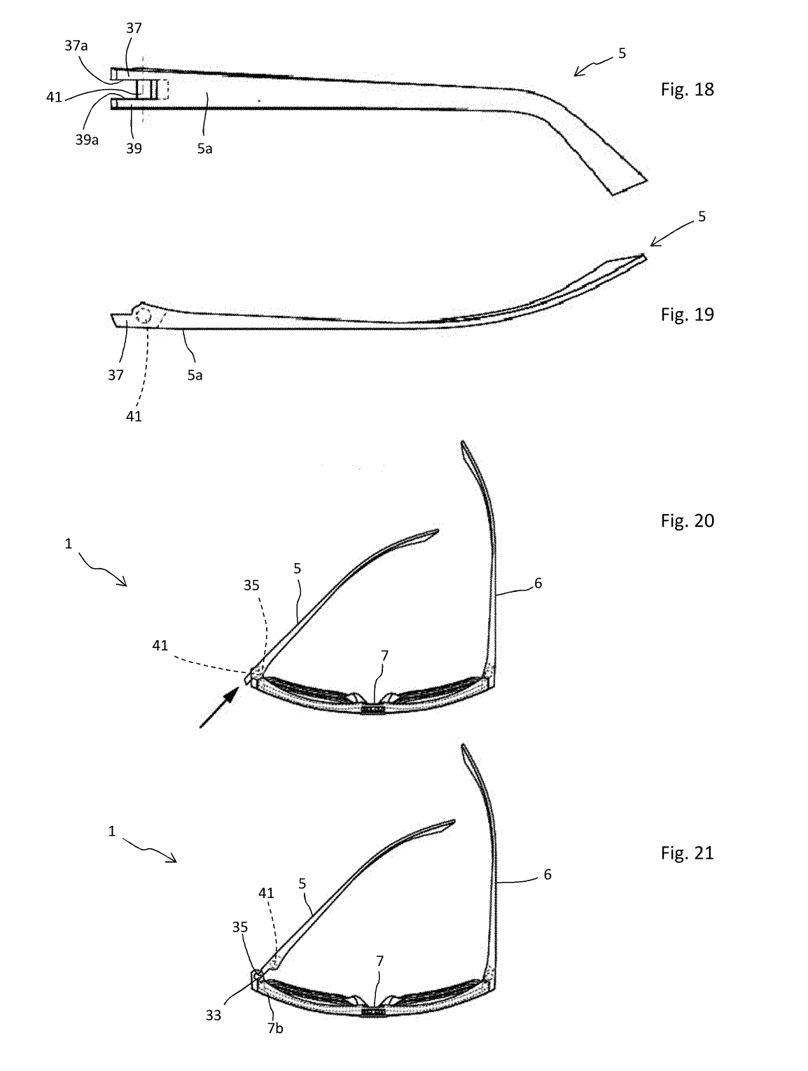

FIGS. 18 and 19 illustrate a temple of the frame, in two different views;

FIGS. 20 and 21 illustrate the disassembly of a temple from the frame;

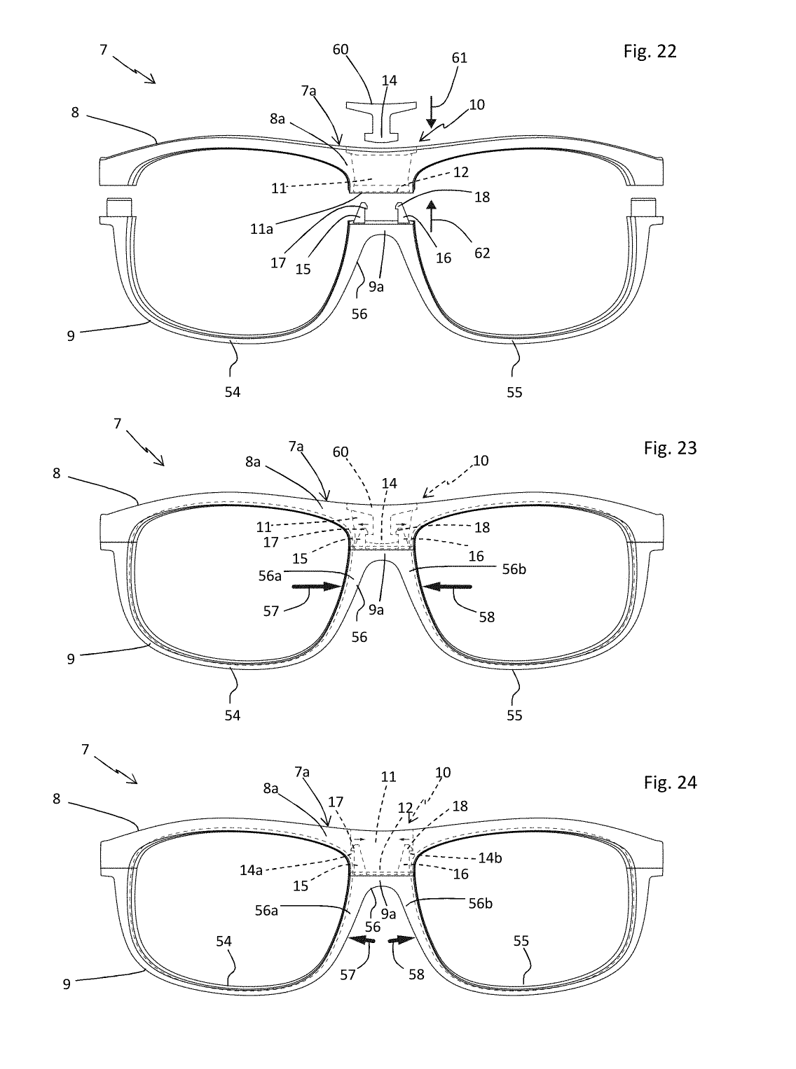

FIGS. 22 and 23 illustrate an alternative embodiment of the engagement system in the central portion of the lens rim;

FIG. 24 illustrates a further alternative embodiment of the engagement system in the central portion of the lens rim;

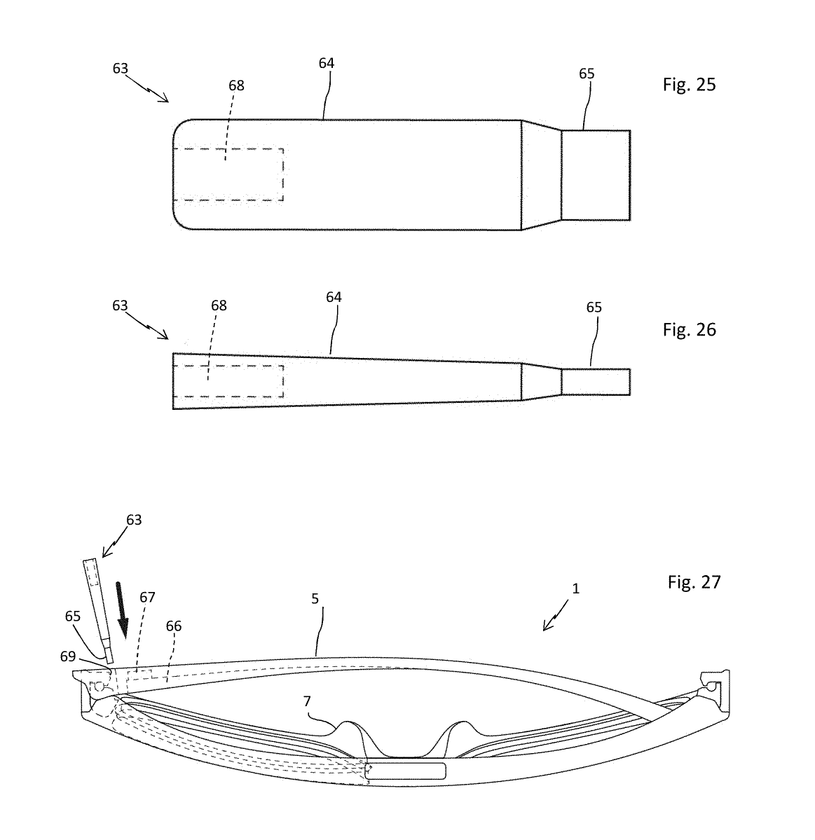

FIGS. 25 and 26 illustrate a tool for releasing the temples from the rim;

FIGS. 27 to 29 illustrate the various steps for releasing a temple with respect to the lens rim, by means of the tool illustrated in FIGS. 25 and 26.

Hereinafter in the description, the same references are used to define the same features of the pair of spectacles, according to the various alternative embodiments thereof.

In FIGS. 1 and 2, the pair of spectacles 1 comprises a frame 2 whereon two lenses 3, 4 are mounted. They may consist of corrective or sun lenses 3, 4, or a combination of both. The frame 2 comprises two temples 5, 6 which are assembled in a pivot connection on a rim 7 receiving the lenses 3, 4. The rim 7 comprises an upper portion 8 and a lower portion 9. The pivoting axes of the temples 5, 6 with respect to the rim 7 define the longitudinal direction of these pivot connections.

An engagement system 10 is implemented in the central portion 7a of the rim 7, between the upper portion 8 and the lower portion 9. The central portion 8a of the upper portion 8 of the rim 7 comprises a housing area 11 which has at the lower edge 11a thereof two holes 12, 13 separated by a tooth 14 extending upwards inside the housing 11, as seen in FIGS. 2, 4 and 7. The central portion 9a of the lower portion 9 of the rim 7 comprises two tabs 15, 16 which extend upwards and each have a claw 17, 18. These claws 17, 18 are arranged facing one another, at the respective upper ends of said tabs 15, 16. These tabs 15, 16 have in combination, a complementary shape to that of the tooth 14. Inserting the tabs 15, 16 inside the holes 12, 13 makes it possible to engage the claws 17, 18 on the tooth 14, as illustrated by FIGS. 9 to 11.

Engagement systems 19, 20 are implemented on the side ends of the rim 7, between the upper portion 8 and the lower portion 9. The side ends 9b, 9c of the lower portion 9 each comprise a stud 21, 22 extending upwards, as illustrated particularly by FIGS. 2 and 9 to 12. The side ends 8b, 8c of the upper portion 8 each comprise an orifice 23, 24 configured to receive the respective stud 21, 22, as illustrated particularly by FIGS. 2 and 9 to 13.

Upon assembling the rim 7, once the engagement system 10 has been positioned between the upper portion 8 and the lower portion 9, as illustrated in FIGS. 9 to 11, the side ends 8b, 8c of the upper portion 8 remain released with respect to the side ends 9b, 9c of the lower portion 9, which facilitates the positioning of the lenses 3, 4 inside the rim 7, as illustrated by FIGS. 11 and 12. Once the lenses 3, 4 have been positioned on the rim 7, the interlocking systems 19, 20 are positioned between the side ends 8b, 8c of the upper portion 8 and the side ends 9b, 9c of the lower portion 9.

FIGS. 3 to 5 illustrate a first embodiment of the rim 7 of the frame 2. In FIGS. 2 and 3, the lower portion 9 of the rim 7 comprises at least of the side ends 9b, 9c thereof, a first longitudinal semi-cylindrical portion 25, 26 which has a first hollow 27, 28. Similarly, in FIGS. 2 and 4, the upper portion 8 of the rim 7 comprises at each of the side ends 8b, 8c thereof, a second longitudinal semi-cylindrical portion 29, 30 which has a second hollow 31, 32 of a complementary shape to the first hollow 27, 28. The longitudinal direction is defined by the pivoting axes of the temples 5, 6 with respect to the rim 7. Upon assembling the upper portion 8 and the lower portion 9, after positioning the interlocking systems 19, 20 between the respective side ends 8b, 8c, 9b, 9c of said upper 8 and lower portions 9, the combination of the first longitudinal semi-cylindrical portion 25, 26 of the lower portion 9 with the second longitudinal semi-cylindrical portion 29, 30 of the upper portion 8, at each of the side ends 7b, 7c of the rim 7, makes it possible to form two hollow cylinders 33, 34 which each have a slot 35, 36, as illustrated in FIG. 5. This involves cutting the hollow cylinders 33, 34 in the longitudinal direction so as to obtain the first longitudinal semi-cylindrical portions 25, 26 and the second longitudinal semi-cylindrical portions 29, 30 of complementary shapes. The shape of the cut in the longitudinal direction may be variable, for example a straight cut in a parallel plane to the pivoting axis, or a serpentine or zigzag cut favouring reduced mobility between said first and second portions once joined, both along the pivoting axis and perpendicularly to said axis.

As illustrated in FIGS. 2, 18 and 19, the temples 5, 6 each comprise at the proximal end 5a, 6a thereof, an upper flat section 37, 38 and a lower flat section 39, 40 which are separated from one another by a distance corresponding to the length of the hollow cylinders 33, 34. A pin 41, 42 extends vertically between the upper flat section 37, 38 and the lower flat section 39, 40, for each of the temples 5, 6. The slots 35, 36 on the hollow cylinders 33, 34 at the side ends 7b, 7c of the rim 7, are proportioned with respect to the diameter of the pins 41, 42 on the temples 5, 6, so as to enable the engagement of said pins 41, 42 inside said respective hollow cylinders 33, 34, by inserting same through said slots 35, 36. Upon engaging the temples 5, 6, on the side ends 7b, 7c of the rim 7, the first longitudinal semi-cylindrical portion 25, 26 and the second longitudinal semi-cylindrical portion 29, 30, joined together by forming the hollow cylinder 33, 34, are now locked at a stop between the upper flat section 37, 38 and the lower flat section 39, 40, which prevents any translational movement along the direction of the pin 41, 42 between said longitudinal semi-cylindrical portions 25, 26, 29, 30. This locking between the first longitudinal semi-cylindrical portion 25, 26 and the second longitudinal semi-cylindrical portion 29, 30 prevents the disengagement of the interlocking system 19, 20 at each side end 7b, 7c of the rim 7.

FIGS. 6 to 8 illustrate an alternative embodiment of the first longitudinal semi-cylindrical portions 25, 26 on the lower portion 9 and of the second longitudinal semi-cylindrical portions 29, 30 on the upper portion 8, for the use of the hollow cylinders 33, 34 provided with a slot 35, 36. The features thereof are similar to those of the alternative embodiment described above and illustrated in FIGS. 3 to 5, only the semi-cylindrical shapes thereof change. It is observed in FIG. 3 that the hollows 27, 28 on the first longitudinal semi-cylindrical portions 25, 26 extend more or less along a quarter of a circle and are oriented towards the external sides, at the side ends 9b, 9c of the lower portion 9. Whereas in FIG. 6, the hollows 27, 28 on the first longitudinal semi-cylindrical portions 25, 26 have more or less the shape of a semicircle and are oriented towards the rear side of the rim 7, at the side ends 9b, 9c of the lower portion 9. Similarly, it is observed in FIG. 4 that the hollows 31, 32 on the second longitudinal semi-cylindrical portions 29, 30 extend over slightly more than a semicircle and are oriented towards the internal sides, at the side ends 8b, 8c of the upper portion 8. Whereas in FIG. 7, the hollows 31, 32 on the second longitudinal semi-cylindrical portions 29, 30 extend over slightly more than a quarter of a circle and are curved towards the inner face 43 of the upper portion 8, which makes it possible to form extensions 44, 45 on these second longitudinal semi-cylindrical portions 29, 30, at the sides ends 7b, 7c of the rim 7, as illustrated in FIGS. 7 and 8, the extensions 44, 45 having a smaller thickness than the similar extensions 44, 45 used for the first alternative embodiment, as illustrated in FIGS. 4 and 5. These extensions 44, 45 according to the second alternative embodiment illustrated in FIGS. 6 to 8, offer greater flexibility to the hollow cylinders 33, 34, which favours the separation of the slots 35, 36 upon inserting the pins 41, 42 through said slots 35, 36, in order to engage the temples 5, 6 on the side ends 7b, 7c of the rim 7.

As illustrated in FIGS. 1 and 2, bearing surfaces 46, 47 on the upper 37 and lower flat sections 39 of the first temple 5 abut against contact surfaces 48, 49 arranged on the side ends 8b, 9b of the upper 8 and lower portions 9. Similarly, bearing surfaces 50, 51 on the upper 38 and lower flat sections 40 of the second temple 6 abut against contact surfaces 52, 53 arranged on the side ends 8c, 9c of the upper 8 and lower portions 9. These stop elements limit the outward pivoting of the temples 5, 6, with respect to the rim 7 and, furthermore, prevent the release of the pins 41, 42 of the temples 5, 6, from the hollow cylinders 33, 34. Indeed, as shown in FIGS. 20 and 21, it is necessary to position the temple 5 more or less in the direction of the orientation of the slot 35 to be able to release the pin 41 from the hollow cylinder 33, at the side end 7b of the rim. The same applies, according to the opposite orientation, for the second temple 6. It is also understood that positioning the temples 5, 6 on the rim 7 requires observation of an identical orientation of said temples 5, 6 with respect to the rim 7, to be able to insert the pins 41, 42 into the hollow cylinders 33, 34, via the slots 35, 36.

FIGS. 14 to 17 illustrate the disassembly of the rim 7 to enable the removal of the lenses 3, 4. As specified above, this disassembly is only possible once the temples 5, 6 have been released from the side ends 7b, 7c of the rim 7, given that the upper 37, 38 and lower flat sections 39, 40 prevent the disengagement of the disengagement systems 19, 20. Once the temples 5,6 have been removed, the interlocking systems 19, 20 between the side ends 8b, 8c, 9b, 9c of the upper 8 and lower portions 9 can be released, which makes it possible to separate the circular elements 54, 55 of the lower portion 9 slightly by means of the flexibility thereof, and release the lenses 3, 4. It is observed in FIGS. 14 and 15 that the engagement system 10 on the central portion 7a of the rim remains functional while the interlocking systems 19, 20 are released. The circular elements 54, 55 are interconnected by a nasal supporting element 56. The flexibility of the lower portion 9 makes it possible to apply pressure in the direction of the arrows 57, 58 illustrated in FIG. 16, on the lateral sides 56a, 56b of this nasal supporting element 56, which makes it possible to separate the claws 17, 18 slightly at the ends of the tabs 15, 16, so as to release these claws 17, 18 from the tooth 14, and remove the tabs 15, 16 from the housing area 11 in the direction of the arrow 59 illustrated in FIG. 17, for the disengagement of the central portion 8a of the upper portion 8 with respect to the central portion 9a of the lower portion 9. The release in the direction of the arrow 59 is performed by holding the lateral sides 56a, 56b of the nasal supporting element 56.

Further alternative embodiments can be envisaged without leaving the scope of the invention. According to the preferential embodiments described above, the first longitudinal semi-cylindrical portions 25, 26 on the lower portion 9 of the rim 7 each form a first longitudinal semi-connection element. Similarly, the second longitudinal semi-cylindrical portions 29, 30 on the upper portion 8 of the rim 7 each form a second longitudinal semi-connection element. These first and second longitudinal semi-connection elements complement one another and form a first female connection element together upon assembling the lower portion 9 and the upper portion 8, forming said rim 7. The pins 41, 42 on the temples 5, 6 form second male connection elements which are each engaged in a first connection element. It is thus understood that it would be possible to envisage an alternative inverted design, whereby the first connection elements would be of the male type and the second connection elements would be of the female type. As such, the first 25, 26 and second 29, 30 longitudinal semi-cylindrical portions each forming a hollow 27, 28, 31, 32 could be replaced by first and second longitudinal solid semi-cylindrical portions each forming a half-pin, the assembly of the upper portion 8 with the lower portion 9 making it possible to join, at each of the side ends 7b, 7c of the rim 7, said first and second longitudinal solid semi-cylindrical portions so as to form a complete connection pin (not illustrated). In this alternative design, the pins 41, 42 on the temples 5, 6 would be removed and replaced by cylindrical notches provided with a slot (not illustrated), arranged coaxially on the inner faces 37a, 38a, 39a, 40a of the upper 37, 38 and lower flat sections 39, 40 illustrated in FIGS. 2 and 18, so as to form female pivot connection elements for receiving by engagement, said complete pins.

FIGS. 22 and 23 show an alternative embodiment of the engagement system 10 described above on the embodiment in FIGS. 1 to 21, which is implemented in the central portion 7a of the rim 7, between the upper portion 8 and the lower portion 9. The central portion 8a of the upper portion 8 of the rim 7 comprises a housing area 11 which has at the lower edge 11a thereof a single hole 12. An insert 60 is configured to be engaged in the housing area 11 by the upper side of the central portion 8a, as illustrated in FIGS. 22 and 23. This insert comprises an inverted T-shaped tooth 14 extending downwards inside the housing 11, as seen in FIGS. 22 and 23. The central portion 9a of the lower portion 9 of the rim 7 comprises two tabs 15, 16 which extend upwards and each have a claw 17, 18. These claws 17, 18 are arranged facing one another, at the respective upper ends of said tabs 15, 16. These tabs 15, 16 have in combination a complementary shape to that of the tooth 14.

Inserting the tabs 15, 16 and the insert 60 into the housing area 11, in the direction of the arrows 61, 62, makes it possible to engage the claws 17, 18 on the tooth 14, as illustrated in FIGS. 22 and 23. The circular elements 54, 55 are interconnected by a nasal supporting element 56. The flexibility of the lower portion 9 makes it possible to apply pressure in the direction of the arrows 57, 58 illustrated in FIG. 23, on the lateral sides 56a, 56b of this nasal supporting element 56, which makes it possible to separate the claws 17, 18 slightly at the ends of the tabs 15, 16, so as to release these claws 17, 18 from the tooth 14, and remove the tabs 15, 16 from the housing area 11, for the disengagement of the central portion 8a of the upper portion 8 with respect to the central portion 9a of the lower portion 9. This insert 60 advantageously avoids leaving the housing area 11 open on the upper side thereof. This design further facilitates the implementation of the disengagement system 10, the manufacturing mould whereof is easier to design than the previous embodiment in FIGS. 1 to 21.

FIG. 24 shows a further alternative embodiment of this disengagement system 10 implemented in the central portion 7a of the rim 7, between the upper portion 8 and the lower portion 9. The central portion 8a of the upper portion 8 of the rim 7 comprises a housing area 11 which has at the lower edge thereof a single hole 12. The housing area 11 comprises on the inner lateral sides thereof two teeth 14a, 14b arranged facing one another, as seen in FIG. 24. The central portion 9a of the lower portion 9 of the rim 7 comprises two tabs 15, 16 which extend upwards and each have a claw 17, 18. These claws 17, 18 are arranged opposite one another, at the respective upper ends of said tabs 15, 16. Inserting the tabs 15, 16 into the housing area 11, makes it possible to engage the claws 17, 18 onto the respective teeth 14a, 14b, as illustrated in FIG. 24. The flexibility of the lower portion 9 makes it possible to apply pressure in the direction of the arrows 57, 58 illustrated in FIG. 24, on the lateral sides 56a, 56b of this nasal supporting element 56, which makes it possible to move the claws 17, 18 slightly closer together at the ends of the tabs 15, 16, so as to release these claws 17, 18 from the teeth 14a, 14b, and remove the tabs 15, 16 from the housing area 11, to disengage the central portion 8a of the upper portion 8 with respect to the central portion 9a of the lower portion 9.

The material used for the design of the upper portion 8 and the lower portion 9 will be chosen so as to offer sufficient flexibility at the slots 35, 36, circular elements 54, 55, lateral sides 56a, 56a of the nasal supporting element 56 and the tabs 15, 16. The material used will be for example nylon, polycarbonate or acetate, or any other suitable material.

The invention also envisages a kit for forming a pair of spectacles 1 suitable for being customised according to the user's wishes or even his/her clothing. As such, the kit comprises a plurality of pairs of temples 5, 6 with varied colours and/or patterns. Similarly, the kit comprises a plurality of upper portions 8 and a plurality of lower portions 9 with varied colours and/or patterns. The kit further comprises a plurality of pairs of lenses 3, 4, for example pairs of corrective lenses with different lens tints, and pairs of sun lenses.

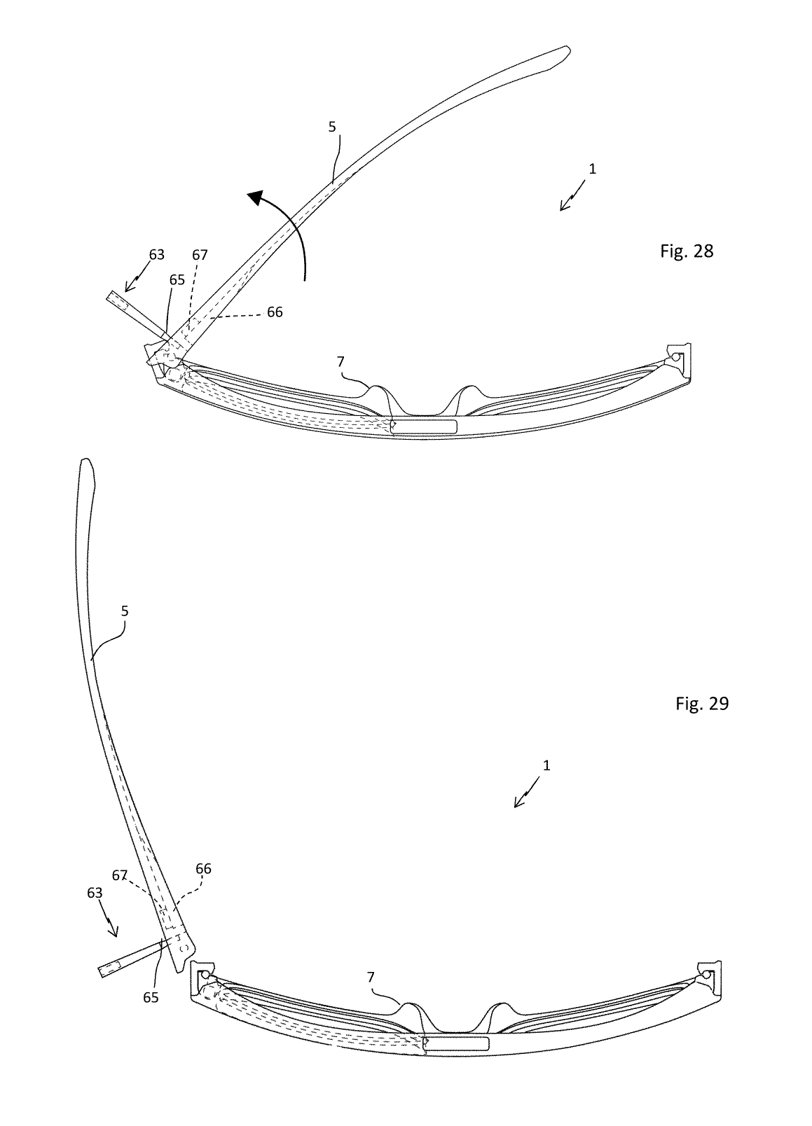

The invention also relates to a kit comprising a pair of spectacles 1 having the features cited above according to one or another of the alternative embodiments described, or any other alternative embodiments, and a tool 63 which makes it possible to disassemble the temples 5, 6 easily with respect to the rim 7, in order to customise said pair of spectacles 1. This tool 63 has the shape of a rod at illustrated in FIGS. 25 and 26, with a body 64 configured to be handled and a head 65 configured to be engaged in an opening 69 on the temple 5, at the connection thereof with the rim 7, as illustrated in particular in FIG. 27, the temple 5 being in the folded down position against the rim 7. Opening the temple 7, as illustrated in FIG. 28 enables the head 65 of the tool 63 to act as a lever or wedge, which constrains the temple 5 to disengage from the rim 7, as illustrated in FIG. 29. Obviously, this tool 63 enables the disengagement of the second temple 6 which is not illustrated in FIGS. 27 to 29. As illustrated in FIGS. 27 to 29, the temple 5 comprises a housing area 66 the shape whereof matches that of the tool 63 illustrated in FIGS. 25 and 26, with slightly larger dimensions, so as to enable the flush fitting of the tool 63 in this housing area 66. The housing area 66 comprises a magnet 67, illustrated in FIGS. 27 to 29. Similarly, the tool 63 comprises a magnet 68 illustrated in FIGS. 25 and 26. These magnets 67, 68 ensure that that tool 63 is secured suitably in the housing area 66. As such, the tool 63 can remain continuously present on the pair of spectacles 1. This tool 63 can be incorporated in the kit cited above which comprises a plurality of upper portions 8 and a plurality of lower portions 9, along with a plurality of pairs of lenses 3, 4, to enable the customisation of the pair of spectacles 1.

1-13. (canceled)

14. A pair of spectacles including a frame which comprises a rim and two temples mounted in a pivot connection with the side ends of said rim, which is provided with an upper portion, a lower portion and assembly means between said portions, the pivoting axis defining a longitudinal direction,
wherein the upper portion includes, at each of the side ends thereof, a first longitudinal semi-connection portion and the lower portion includes, at each of the side ends thereof, a second longitudinal semi-connection portion, the first and second longitudinal semi-connection portions being obtained by cutting a first female or male connection element in the longitudinal direction, said first and second longitudinal semi-connection portions complementing one another and being configured so as to form a first female or male connection element, upon assembling the upper portion and the lower portion, said first connection element being configured to receive a second male or female connection element, arranged at the end of each respective temple.

15. The pair of spectacles according to claim 14, wherein the upper portion comprises at each of the side ends thereof a first hollow semi-cylindrical portion and the lower portion comprises at each of the side ends thereof a second hollow semi-cylindrical portion, the first and second hollow semi-cylindrical portions complementing one another and being configured such that, upon assembling the upper portion and the lower portion, said first and second portions form a hollow cylinder provided with a longitudinal slot designed to enable the engagement of a pin arranged at the end of each respective temple.

16. The pair of spectacles according to claim 14, wherein stop means are arranged at the ends of the temples, the stop means being configured to lock the longitudinal translation of the first longitudinal semi-connection portion with respect to the second longitudinal semi-connection portion upon mounting each temple on the rim.

17. The pair of spectacles according to claim 16, wherein the upper portion comprises at each of the side ends thereof a first hollow semi-cylindrical portion and the lower portion comprises at each of the side ends thereof a second hollow semi-cylindrical portion, the first and second hollow semi-cylindrical portions complementing one another and being configured such that, upon assembling the upper portion and the lower portion, said first and second portions form a hollow cylinder provided with a longitudinal slot designed to enable the engagement of a pin arranged at the end of each respective temple, and wherein each temple comprises at the end thereof an upper flat section and a lower flat section between which extends the pin, said upper and lower flat sections forming stops configured to lock the translation along said pin of the first semi-cylindrical portion with respect to the second semi-cylindrical portion.

18. The pair of spectacles according to claim 14, wherein the assembly means comprise an engagement system arranged between the upper portion and the lower portion of the rim, in a central portion of said rim.

19. The pair of spectacles according to claim 18, wherein the lower portion of the rim comprises in the central portion thereof a nasal supporting element, the engagement system being configured to favour the disengagement of the lower portion with respect to the upper portion by pressing on said nasal supporting element.

20. The pair of spectacles according to claim 14, wherein the assembly means comprise two interlocking systems arranged between the upper portion and the lower portion of the rim, at the two side ends of said rim, respectively.

21. The pair of spectacles according to claim 15, wherein the first semi-cylindrical portion and the second semi-cylindrical portion are configured to increase the flexibility of at least one of said semi-cylindrical portions so as to facilitate the separation of the slot upon the engagement or disengagement of the pin of the temple.

22. A kit for forming a pair of spectacles according to claim 14, which comprises at least one upper portion, at least one lower portion, at least one pair of lenses and at least one pair of temples.

23. The kit according to claim 22, which comprises at least one pair of corrective lenses and one pair of sun lenses.

24. The kit according to claim 22, which comprises at least two pairs of temples of different colours or patterns.

25. A kit comprising a pair of spectacles according to claim 14 and a tool configured to enable the disassembly of the temples by inserting said tool into each temple and opening the temple outwards with respect to the rim.

26. The kit according to claim 25, wherein one of the temples comprises a housing area configured to receive and hold the tool in the storage position.
